(19) United States
(12) Patent Application Publication
(10) Pub. No.: US 2012/0026002 A1
(43) Pub. Date: Feb. 2, 2012

(54) System and Method for Remote Well Monitoring

(75) Inventors: George Hoang Vu, Magnolia, TX (US); Thomas Lee Hitt, Katy, TX (US); Wilbert J. Chenevert, Cypress, TX (US)

(73) Assignee: Halliburton Energy Services Inc., Houston, TX (US)

(21) Appl. No.: 13/260,808

(22) PCT Filed: Dec. 7, 2009
(86) PCT No.: PCT/US2009/066970

§ 371 Date: Sep. 28, 2011

(51) Int. Cl. G01V 3/00

(52) U.S. Cl. 340/854.6

(57) ABSTRACT

A system for remote monitoring of a wellsite operation comprises a sensor disposed at a wellsite to measure a parameter of interest. An information handling system in data communication with the sensor acts according to programmed instructions to generate a predetermined screenshot related to the parameter of interest. A radio frequency transceiver is in data communication with the information handling system to transmit the predetermined screenshot. A personal mobile device comprises a radio frequency transceiver and a display wherein the personal mobile device receives and displays the transmitted predetermined screenshot on the personal mobile device display.

### BACKGROUND OF THE INVENTION

The present disclosure relates generally to the field of telemetry systems for transmitting information through a flowing fluid. More particularly, the disclosure relates to the field of signal detection in such a system.

Drilling and home office personnel are being asked to remotely monitor multiple wells at a time. While online, real time monitoring is available in the office/home environment, the continuous nature of the drilling operational process makes remote well monitoring using personal mobile devices would allow substantially continuous access to well site data.

### BRIEF DESCRIPTION OF THE DRAWINGS

A better understanding of the present invention can be obtained when the following detailed description of example embodiments are considered in conjunction with the following drawings, in which:

FIG. 1 is a network diagram of an example system for monitoring wellsite data;

FIG. 2 illustrates an example IHS 33 that may be used for acquiring and monitoring wellsite data;

FIG. 3 shows the architecture of one example of a personal mobile device;

FIG. 4 shows an example of a wellsite drilling system;

FIG. 5A shows an example of a wellsite wireline logging system;

FIG. 5B shows an example of a wellsite completion system;

FIG. 6 shows an example of a wellsite production system;

FIG. 7 shows another example of a system for remote monitoring and control of a wellsite system;

FIG. 8 is an example flow diagram for monitoring of wellsite data;

FIG. 9 shows an example of a graphical user interface (GUI) screenshot of operational drilling and logging wellsite data;

FIG. 10 illustrates an example GUI screenshot on a personal mobile device (PMD) for user login;

FIG. 11 illustrates a GUI screenshot showing an expanded tree structure for an interactive selection of operational screens and well logging plots on a PMD;

FIG. 12 illustrates a GUI screenshot of an operational screen with operating data and an interactive menu bar on a PMD;

FIG. 13 illustrates a GUI screenshot of a well log displayed on a PMD;

FIG. 14 illustrates a GUI screenshot of a command screen displayed on a PMD; and

FIG. 15 shows one example of a flow chart for one embodiment of a method according to the present disclosure.

### DETAILED DESCRIPTION

A system 100 comprises a network 102 that couples together at least one personal mobile device (PMD) 106A-106N to at least one wellsite 104A-104N. The wellsites 104A-104N may comprise information handling systems (IHS) 33A-33N that may collect, process, store, and display various wellsite data and real time operating parameters. For example, IHS 33 may receive wellsite data from various sensors at the wellsite (including downhole and surface sensors), as described below. Network 102 may comprise multiple communication networks working in conjunction with multiple servers.

For purposes of this disclosure, an information handling system may comprise any instrumentality or aggregate of instrumentalities operable to compute, classify, process, transmit, receive, retrieve, originate, switch, store, display, manifest, detect, record, reproduce, handle, or utilize any form of information, intelligence, or data for scientific, control, or other purposes.

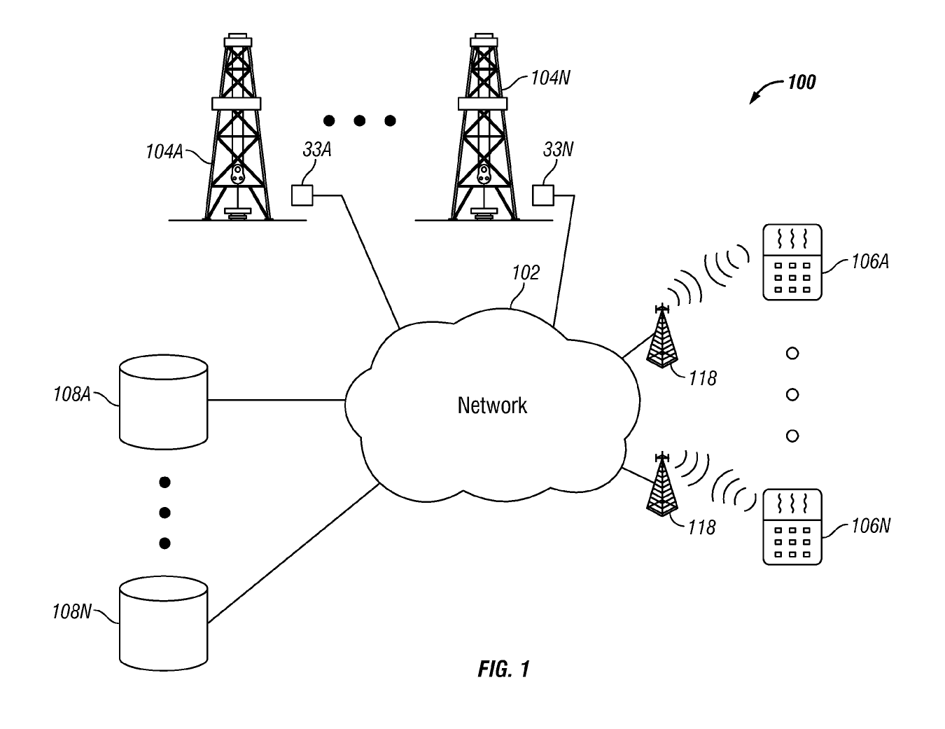

The wellsite data may be replicated at one or more remote locations relative to the wellsite. For example, IHS 33 may transmit the wellsite data to one or more of the non-volatile machine-readable media 108. In addition IHS 33 may transmit data via network 102 and radio frequency transceiver 118 to PMD's 106A-N. In some embodiments, the non-volatile machine-readable media 108 may be representative of servers for storing the wellsite data therein. The network communication may be any combination of wired and wireless communication. In one example, at least a portion of the communication is transferred across the internet using TCP/IP internet protocol. In some embodiments, the network communication may be based on one or more communication protocols (e.g., HyperText Transfer Protocol (HTTP), HTTP Secured (HTTPS), Application Data Interface (ADI), Well Information Transfer Standard Markup Language (WITSML), etc.). A particular non-volatile machine-readable medium 108 may store data from one or more wellsites and may be stored and retrieved based on various communication protocols. The non-volatile machine-readable media 108 may include disparate data sources (such as ADI, Javi Application Data Interface (JADI), Well Information Transfer Standard Markup Language (WISTML), Log ASCII Standard (LAS), Log Information Standard (LIS), Digital Log Interchange Standard (DLIS), Well Information Transfer Standard (WITS), American Standard Code for Information Interchange (ASCII), OpenWorks, SiesWorks, Petrel, Engineers Data Model (EDM), Real Time Data (RTD), Profibus, Modbus, OLE Process Control (OPC), various RF wireless communication protocols (such as Code Division Multiple Access (CDMA), Global System for Mobile Communications (GSM), etc.), Video/Audio, chat, etc.). While the system 100 shown in FIG. 1 employs a client-server architecture, embodiments are not limited to such an architecture, and could equally well find application in a distributed, or peer-to-peer, architecture system.

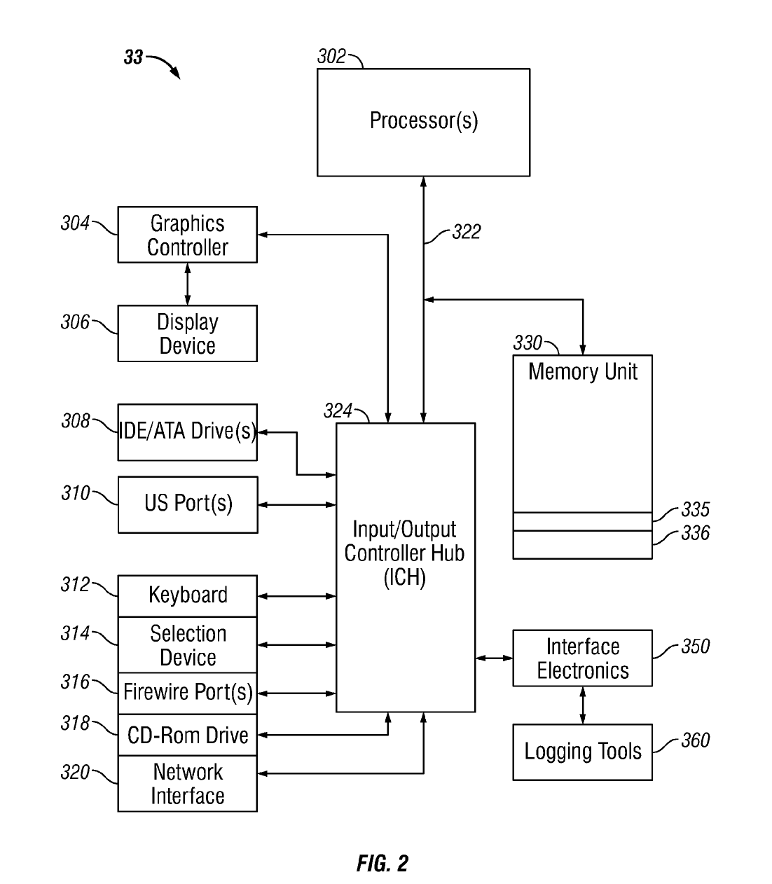

FIG. 2 illustrates an example IHS 33 that may be used for acquiring and monitoring wellsite data, according to some embodiments. In the example shown IHS 33 comprises processor(s) 302. IHS 33 may also comprise a memory unit 330, processor bus 322, and Input/Output controller hub (ICH) 324. The processor(s) 302, memory unit 330, and ICH 324 are coupled to the processor bus 322. The processor(s) 302 may comprise any suitable processor architecture. IHS 33 may comprise one, or more, processors, any of which may execute a set of instructions in accordance with embodiments of the invention.

The memory unit 330 may store data and/or instructions, and may comprise any suitable memory, such as a dynamic random access memory (DRAM). IHS 33 also comprises hard drives such as IDE/ATA drive(s) 308 and/or other suitable computer readable media storage and retrieval devices. A graphics controller 304 controls the display of information on a display device 306, according to some embodiments of the invention.

The input/output controller hub (ICH) 324 provides an interface to I/O devices or peripheral components for IHS 33. The ICH 324 may comprise any suitable interface controller to provide for any suitable communication link to the processor(s) 302, memory unit 330 and/or to any suitable device or component in communication with the ICH 324. In one embodiment of the invention, the ICH 324 provides suitable arbitration and buffering for each interface. In one embodiment a wellsite monitoring application 335 and a mobile wellsite monitoring application 336 are stored in memory unit 330. Mobile wellsite monitoring application 336 interfaces with wellsite monitoring application 335 and enables PMD 106 to access, over network 102, the data collected and processed by wellsite monitoring application 335.

ICH 324 may also interface with downhole logging tools 360 (described below), through interface electronics 350. Interface electronics 350 may contain analog and/or digital circuitry to at least receive signals from logging tools 360, convert them to data suitable for input to processor 302. Such circuits are known to those skilled in the art, and are not described in detail here.

For some embodiments of the invention, the ICH 324 provides an interface to one or more suitable integrated drive electronics (IDE) drives 308, such as a hard disk drive (HDD) or compact disc read only memory (CD ROM) drive, or to suitable universal serial bus (USB) devices through one or more USB ports 310. In one embodiment, the ICH 324 also provides an interface to a keyboard 312, a mouse 314, a CD-ROM drive 318, one or more suitable devices through one or more firewire ports 316. For one embodiment of the invention, the ICH 324 also provides a network interface 320 though which IHS 33 can communicate with other computers and/or devices.

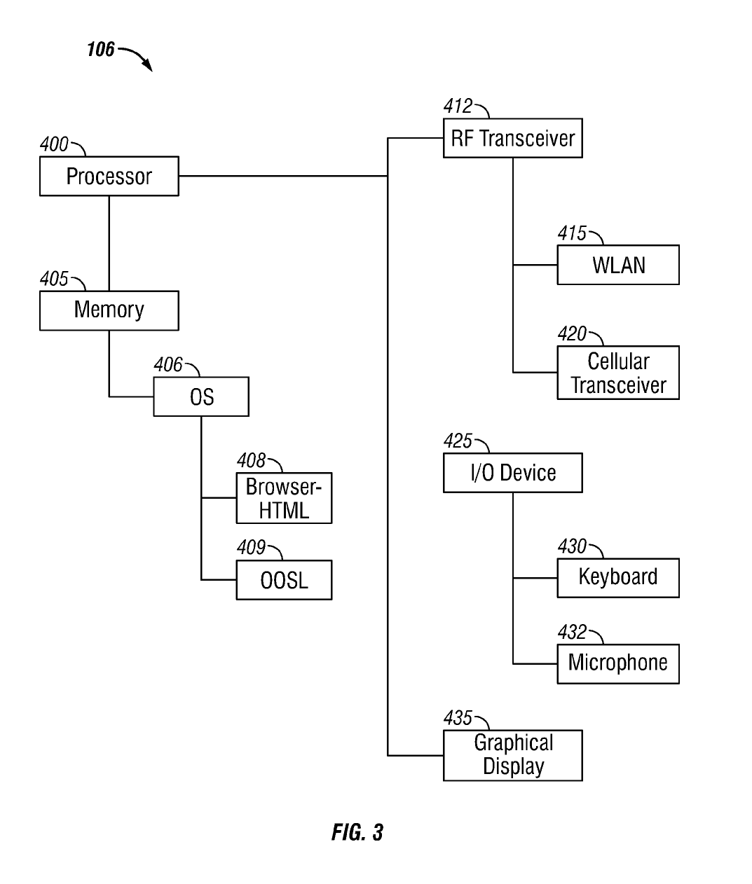

FIG. 3 shows the architecture of one example of PMD 106. As shown, PMD 106 comprises a processor 400 in data communication with a memory 405 suitable for storing an operating system (OS) 406. Processor 400 is connected by an interface bus 410 to various components comprising: a radio frequency transceiver 412 that may comprise a wireless local area network (WLAN) transceiver 415; a cellular transceiver 420; or both. Other components comprise an input/output device 425; and a graphical display 435. In one example, WLAN transceiver 415 is a Wi-Fi device. Cellular transceiver 420 may transmit and receive signals in any suitable cellular protocol including, but not limited to CDMA and GSM.

Input/output device 425 may comprise a keyboard 430. Keyboard 430 may comprise physical keys, or alternatively, keyboard 430 may be implemented as a touchscreen keyboard. Input/output device 425 may also comprise a microphone for inputting voice commands using voice recognition applications known in the art. In one example, graphic display 435 comprises a suitable graphic display having a pixel resolution of at least 160 by 160 pixels. In one embodiment, personal mobile device 106 weighs no more than about one pound. In one example, OS 406 is able to run an internet/intranet web browser 408 enabling HTML. In another example, OS 406 may also be able to run an object oriented scripting language (OOSL) 409, for example the Javascript brand object oriented scripting language developed by Sun Microsystems, Inc.

In one embodiment, PMD 106 described above may comprise a smartphone. Such a smartphone may include, but are not limited to: the Iphone by Apple Inc.; various Blackberry models by Research in Motion, Inc.; the Palm Treo by Palm Inc.; and any other suitable smartphone now known or developed in the future that has the characteristics described above. Each of the phones described above has a suitable OS for executing the actions and instructions described above. Alternatively, PMD 106 may comprise a personal digital assistant (PDA) device. PDA's have many of the functional attributes of the smartphone described but may not have voice communication commonly associated with the smartphone. Examples include, but are not limited to, Apple's IPOD Touch brand and Hewlett Packard's IPAQ brand of PDA's. In addition, any satellite phone having the characteristics described herein may be used.

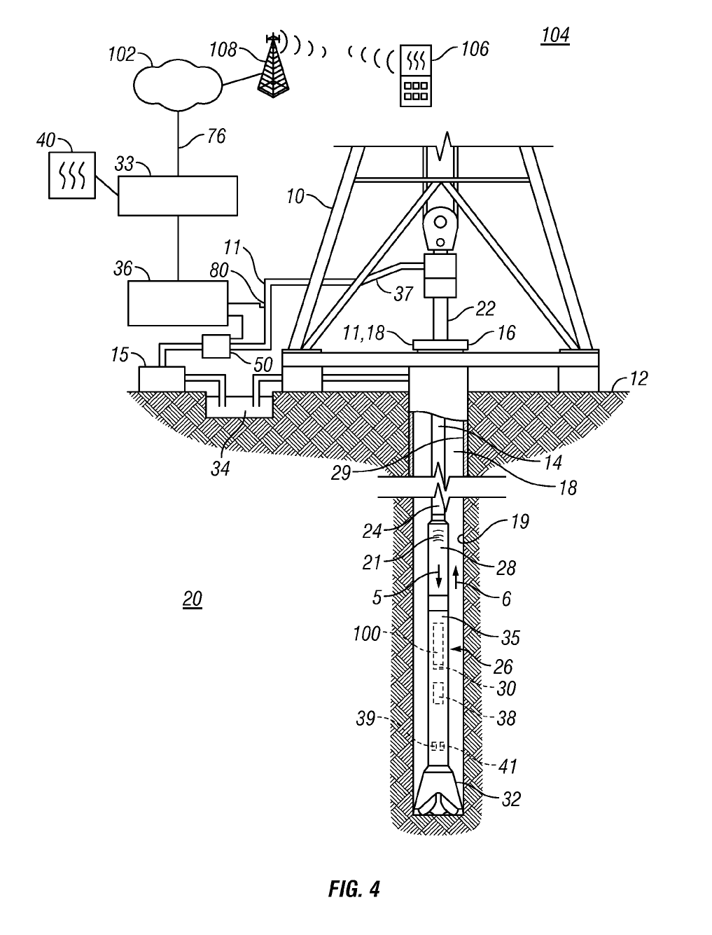

Described below are operational examples of wellsite systems, for example, a drilling and logging system, and a production system, where data may be acquired, processed, and transmitted over the internet/intranet to such a PMD as described above. Referring to FIG. 4, a drilling system 104 is illustrated which includes a drilling derrick 10, constructed at the surface 12 of the well, supporting a drill string 14. The drill string 14 extends through a rotary table 16 and into a borehole 18 that is being drilled through earth formations 20. The drill string 14 may include a kelly 22 at its upper end, drill pipe 24 coupled to the kelly 22, and a bottom hole assembly 26 (BHA) coupled to the lower end of the drill pipe 24. The BHA 26 may include drill collars 28, an MWD tool 30, and a drill bit 32 for penetrating through earth formations to create the borehole 18. In operation, the kelly 22, the drill pipe 24 and the BHA 26 may be rotated by the rotary table 16. Alternatively, or in addition to the rotation of the drill pipe 24 by the rotary table 16, the BHA 26 may also be rotated, as will be understood by one skilled in the art, by a downhole motor (not shown). The drill collars add weight to the drill bit 32 and stiffen the BHA 26, thereby enabling the BHA 26 to transmit weight to the drill bit 32 without buckling. The weight applied through the drill collars to the bit 32 permits the drill bit to crush the underground formations.

As shown in FIG. 4, BHA 26 may comprise an MWD tool 30, which may be part of the drill collar section 28. As the drill bit 32 operates, drilling fluid (commonly referred to as “drilling mud”) may be pumped from a mud pit 34 at the surface by pump 15 through standpipe 11 and kelly hose 37, through drill string 14, indicated by arrow 5, to the drill bit 32. The drilling mud is discharged from the drill bit 32 and functions to cool and lubricate the drill bit, and to carry away earth cuttings made by the bit. After flowing through the drill bit 32, the drilling fluid flows back to the surface, indicated by arrow 6, through the annular area between the drill string 14 and the borehole wall 19, or casing wall 29. At the surface, it is collected and returned to the mud pit 34 for filtering. In one example, the circulating column of drilling mud flowing through the drill string may also function as a medium for transmitting pressure signals 21 carrying information from the MWD tool 30 to the surface.

MWD tool 30 may comprise sensors 39 and 41, which may be coupled to appropriate data encoding circuitry, such as an encoder 38, which sequentially produces encoded digital data electrical signals representative of the measurements obtained by sensors 39 and 41. While two sensors are shown, one skilled in the art will understand that a smaller or larger number of sensors may be used without departing from the scope of the present invention. The sensors 39 and 41 may be selected to measure downhole parameters including, but not limited to, environmental parameters, directional drilling parameters, and formation evaluation parameters. Such parameters may comprise downhole pressure, downhole temperature, the resistivity or conductivity of the drilling mud and earth formations, the density and porosity of the earth formations, as well as the orientation of the wellbore. Sensor examples include, but are not limited to: a resistivity sensor, a nuclear porosity sensor, a nuclear density sensor, a magnetic resonance sensor, and a directional sensor package. In addition, formation fluid samples and/or core samples may be extracted from the formation using formation tester. Such sensors and tools are known to those skilled in the art.

In one example, data representing sensor measurements of the parameters discussed above may be generated and stored in the MWD tool 30. Some or all of the data may be transmitted by data signaling unit 35, through the drilling fluid in drill string 14. A pressure signal travelling in the column of drilling fluid may be detected at the surface by a signal detector unit 36 employing a pressure detector 80 in fluid communication with the drilling fluid. The detected signal may be decoded in IHS 33. In one embodiment, a downhole data signaling unit 35 is provided as part of MWD tool 30. Data signaling unit 35 may include a pressure signal transmitter 100 for generating the pressure signals transmitted to the surface. The pressure signals may comprise encoded digital representations of measurement data indicative of the downhole drilling parameters and formation characteristics measured by sensors 39 and 41. Alternatively, other types of telemetry signals may be used for transmitting data from downhole to the surface. These include, but are not limited to, electromagnetic waves through the earth and acoustic signals using the drill string as a transmission medium. In yet another alternative, drill string 14 may comprise wired pipe enabling electric and/or optical signals to be transmitted between downhole and the surface. In one example, IHS 33 may be located proximate the rig floor. Alternatively, IHS 33 may be located away from the rig floor. In one embodiment, IHS 33 may be incorporated as part of a logging unit. In one embodiment, a surface transmitter 50 may transmit commands and information from the surface to the downhole MWD/LWD system. For example, surface transmitter 50 may generate pressure pulses into the flow line that propagate down the fluid in drill string 14, and may be detected by pressure sensors in MWD tool 30. The information and commands, may be used, for example, to request additional downhole measurements, to change directional target parameters, to request additional formation samples, and to change downhole operating parameters.

In addition to downhole measurements, various surface parameters may be measured using sensors 17, 18 located at the surface. Such parameters may comprise rotary torque, rotary RPM, well depth, hook load, standpipe pressure, and any other suitable parameter of interest.

The surface and downhole parameters may be processed by IHS 33 using software for the operation and management of drilling, completion, production, and servicing of onshore and offshore oil and gas wells, for example the Insite® brand of software owned by Halliburton, Inc. In one embodiment, the software produces data that may be presented to the driller and operational personnel in a variety of visual display presentations, for example, on display 40. Alternatively, any suitable processing application package may be used.

The processed information may be transmitted by IHS 33 via communication link 76 to network 102 that couples one or more wellsites to one or more PMD's 106 via a radio frequency transceiver 108, for example, a cellular link, a WiFi link, and a satellite link. In one embodiment, PMD 106 may be used to transmit commands back to IHS 33, via the RF and network path. Such commands may be used, for example, to request additional downhole measurements, to change directional target parameters, to request additional formation samples, and to change downhole operating parameters

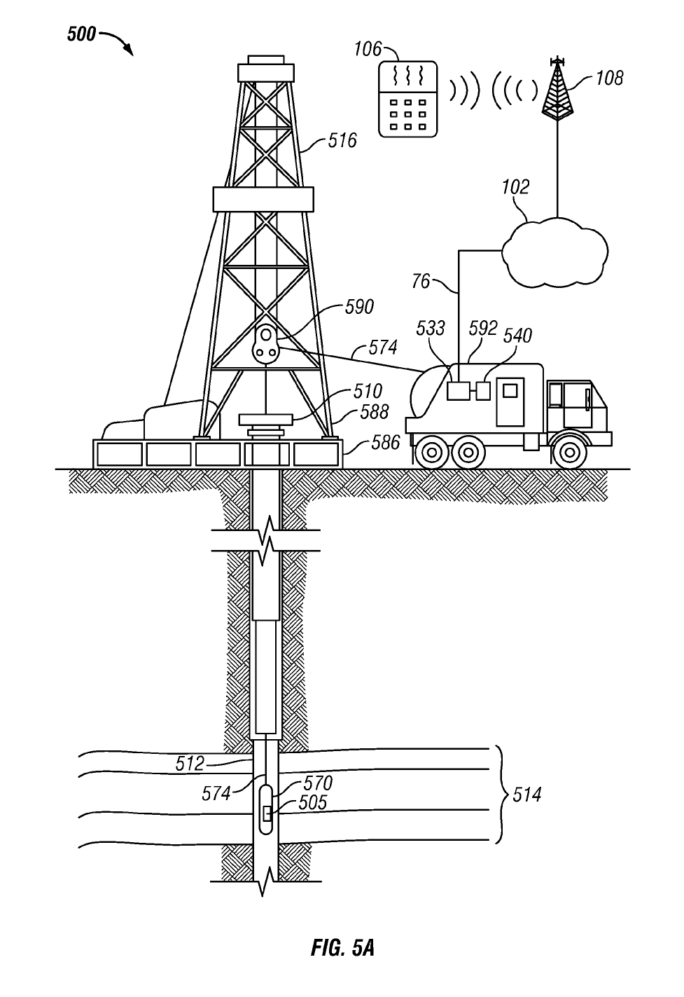

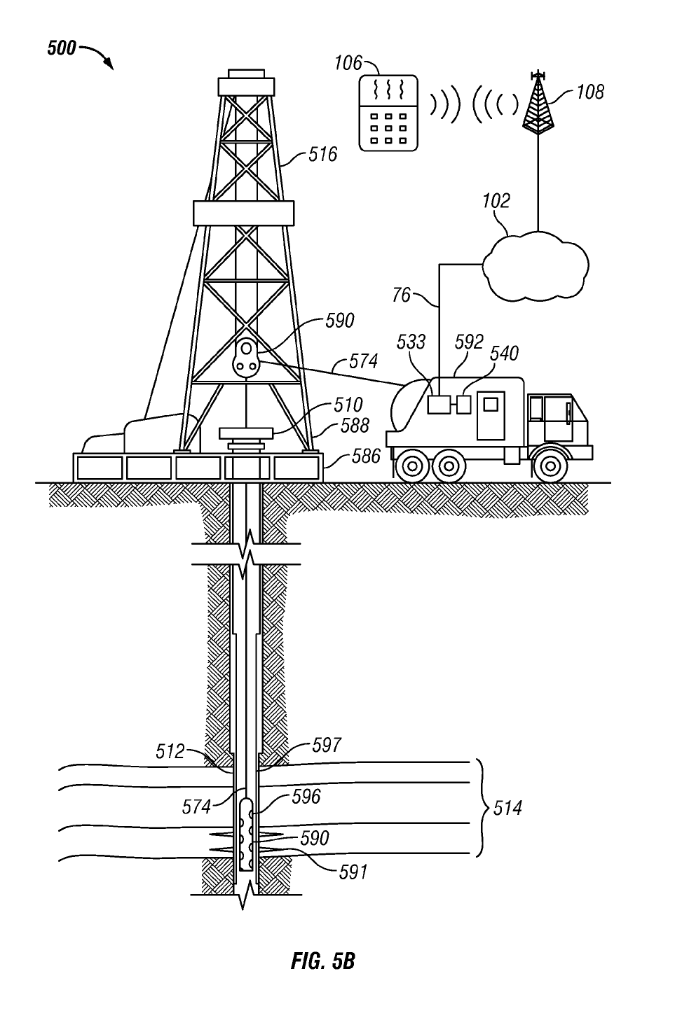

FIG. 5A illustrates an example of a wireline logging system 500. A derrick 516 supports a pulley 590. Drilling of oil and gas wells is commonly carried out by a string of drill pipes connected together so as to form a drilling string that is lowered through a rotary table 510 into a wellbore or borehole 512. Here it is assumed that the drilling string has been temporarily removed from the borehole 512 to allow a wireline logging tool 570, such as a probe or sonde, to be lowered by wireline or logging cable 574 into the borehole 512. The wireline logging cable 574 may have one or more electrical and/or optical conductors for communicating power and signals between the surface and the logging tool 570. Typically, the tool 570 is lowered to the bottom of the region of interest and subsequently pulled upward. During the upward trip, sensors 505 located in the tool 570 may be used to perform measurements on the subsurface formations 514 adjacent the borehole 512 as they pass by. Measurements may comprise those described above with respect to MWD/LWD operations.

The measurement data can be communicated to an IHS 533 in logging unit 592 for storage, processing, and analysis. The logging facility 592 may be provided with electronic equipment for various types of signal processing. Similar log data may be gathered and analyzed during drilling operations (e.g., during Logging While Drilling, or LWD operations). The log data may also be displayed at the rig site for use in the drilling and/or completion operation on display 540. In one example, measured wellsite data may be processed by a wellsite monitoring application resident in IHS 533 as described above. The processed information may be transmitted by IHS 533 via communication link 76 to network 102 that couples one or more wellsites to one or more PMD's 106 via a radio frequency transceiver 108, for example, a cellular link or a WiFi link. In one embodiment, PMD 106 may be used to transmit commands back to IHS 533, via the RF and network path. Such commands may comprise, for example, requests for additional downhole measurements, changes in measurement parameters, and requests for additional formation samples.

FIG. 5B shows an example wireline completion system using deployment equipment similar to that of FIG. 5A. In this example, a perforating tool 590 is connected to wireline 574 and is deployed in casing 597. Perforating tool 590 may have electronic circuits for interfacing with surface IHS 533. In addition, perforating tool 590 may have sensors (not shown) for detecting each casing joint so that the location of the perforating tool 590 may be accurately determined at the surface. Perorating tool comprises shaped explosive charges 596 that may be triggered from the surface to create perforations 591 through casing 597 and into formation 514. Such penetrations provide a flow path for fluids in the formation to the production tubing. In one example, information, for example the location of the perforating tool 590 and the logging information for the formation 514 proximate the perforating tool may be transmitted may be transmitted by IHS 533 via communication link 76 to network 102 that couples one or more wellsites to one or more PMD's 106 via a radio frequency transceiver 108, for example, a cellular link or a WiFi link. In one embodiment, PMD 106 may be used to transmit commands back to IHS 533, via the RF and network path. Such commands may comprise, for example, commands to perforate at an indicated downhole location.

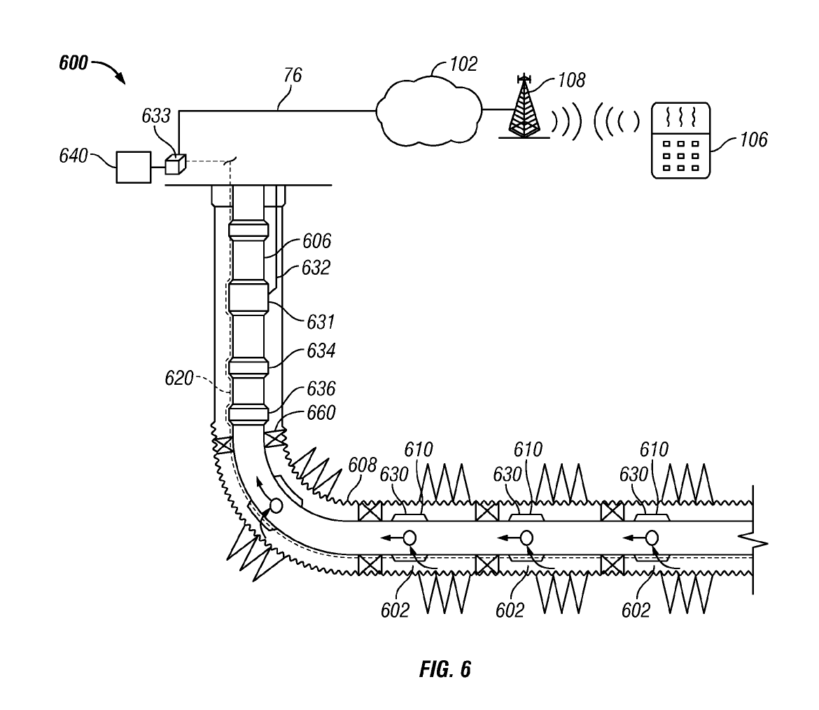

FIG. 6 shows an example of a production well system 600. A production tubing string 606 is disposed in a well 608. One or more interval control valves 610 are disposed in tubing string 606 and provide an annulus to tubing flow path 602. Sensors 630 may be incorporated in interval control valves 610 detecting reservoir data. Interval control valve 610 may include a choking device that isolate the reservoir from the production tubing 606. It will be understood by those skilled in the art that there may be an interrelationship between one control valve and another. For example, as one valve is directed to open, another control valve may be directed to close. A production packer 660 provides a tubing-to-casing seal and pressure barrier, isolates zones and/or laterals from the well bore 608 and allows passage of an electro-hydraulic umbilical 620. Packer 660 may be a hydraulically set packer that may be set using the system data communications and hydraulic power components. The system may also include other components well known in the industry including safety valve 631, control line 632, gas lift device 634, and disconnect device 636. It will be understood by those skilled in the art that the well bore may be cased partially having an open hole completion or may be cased entirely.

A surface IHS 633 may act according to programmed instructions to operate the downhole interval control valves 610 in response to sensed reservoir parameters. In one example, measured reservoir data may be processed by a wellsite production monitoring application resident in IHS 633. The processed information may be transmitted by IHS 633 via communication link 76 to network 102 that couples one or more wellsites to one or more PMD's 106 via a radio frequency transceiver 108, for example, a cellular link or a WiFi link. In one embodiment, PMD 106 may be used to transmit commands back to IHS 633, via the RF and network path. Such commands may comprise, for example, requests for additional reservoir measurements, and commands to open or close various interval control valves 610. In one embodiment, data from multiple wells in a production field may be processed and transmitted.

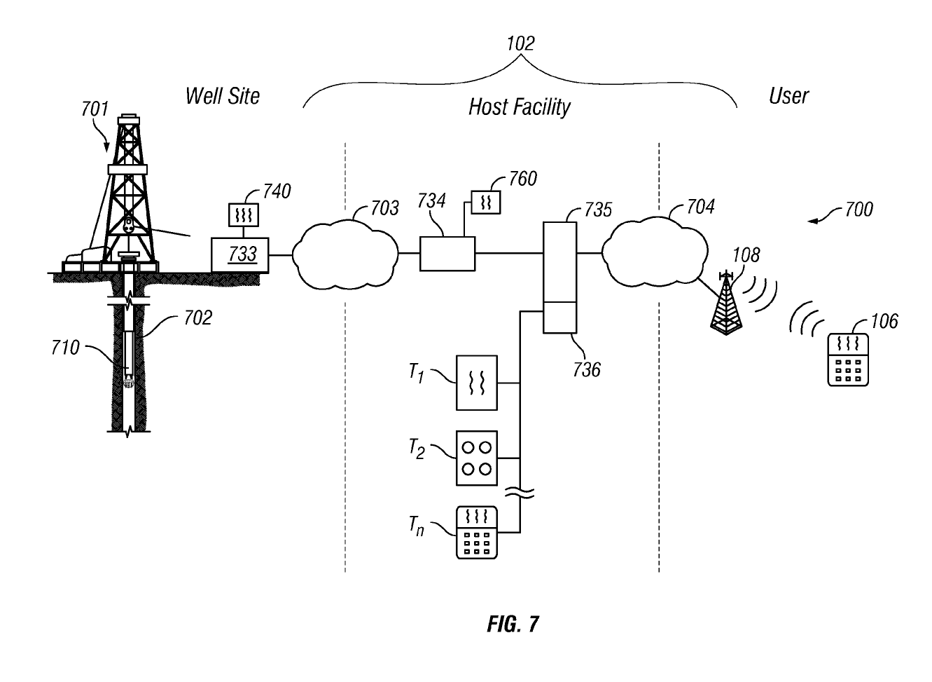

FIG. 7 shows an example of a system 700 for remote monitoring and control of a wellsite system. Well system 701 may be at least one of drilling system, a logging system, a completion system, a production system and combinations thereof, as previously described. IHS 733 acquires downhole measurement data from sensors 710 in well 702. IHS 733 may process this data as described previously using an application program resident in IHS 733. In one example IHS 733 may display portions of the data on display 740. In one example, the processed data may be transmitted using a suitable protocol across a network 703 to IHS 734 at a host facility. Network 703 may be an intranet, the internet, or a combination thereof. IHS 734 may have additional application programs resident therein to further process the wellsite data and display information on display 760. IHS 734 is in data communication with IHS 735. IHS 735 may act as a network server. IHS 735 has a template generation application program 736 in a memory of IHS 735. Template generation program 736 provides predetermined format templates, T₁-Tₙ that present at least portions of the data from wellsite 701 in a suitable visual format, also called a virtual terminal herein, that facilitates client interpretation of wellsite status. Templates are available based on the user authentication privileges during login. Each template provides a screenshot of at least one operational and/or logging process. As used herein, a screenshot is an image of the visible items displayed on a display, for example the data displayed on displays 740 and 760. In one example, the data is presented in substantially real time (allowing for network transmission delays). In one embodiment, the visual presentation template T may be captured and transmitted, on demand, over network 704, and via an RF link 108 to a user's PMD 106. In addition, predetermined commands, as described previously, may be returned from PMD 106 across the system 700 to effect changes in operation at wellsite 701.

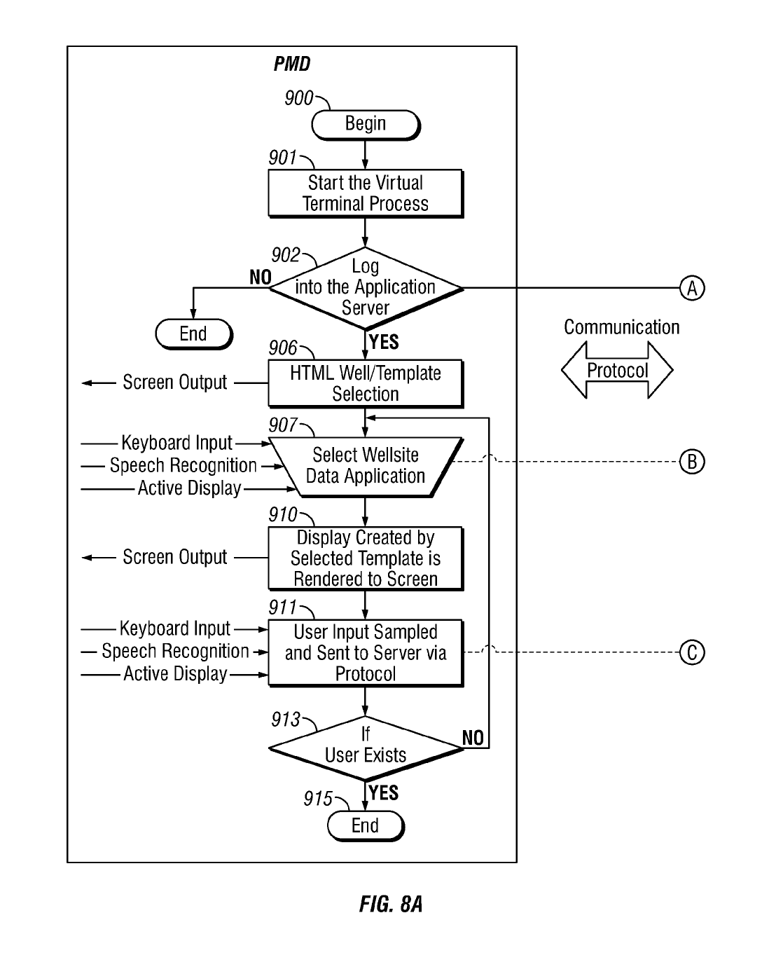

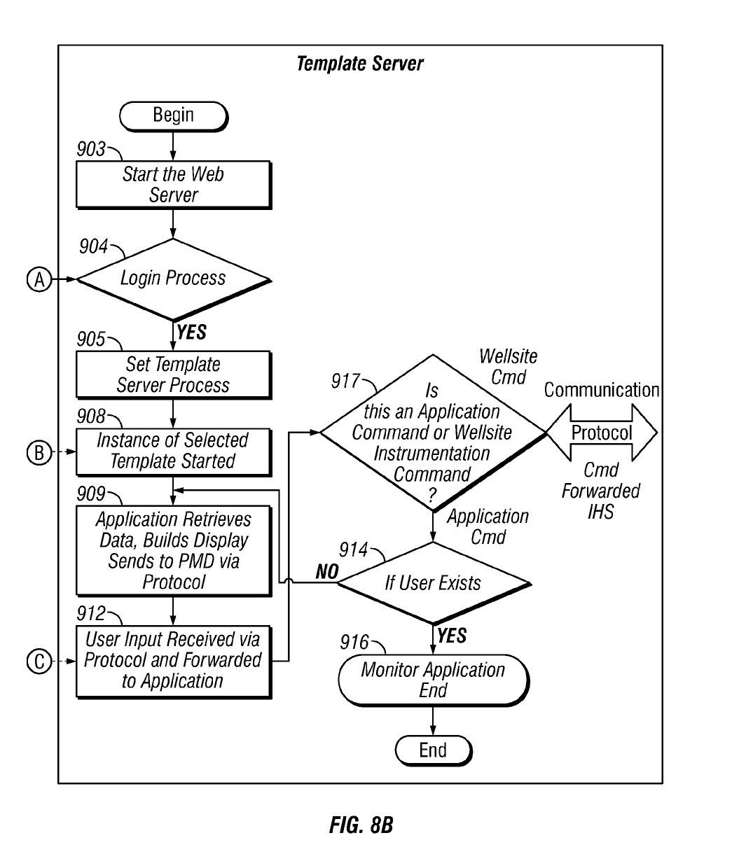

FIG. 8 is a flow diagram for monitoring of wellsite data, according to some embodiments. The flow diagram 900 is described with reference to the system of FIG. 7. The flow diagram commences at block 901.

At block 901, the user invokes the client virtual terminal on PMD 106, in some embodiments this could comprise internet browser.

At block 902, the user supplies authentication credentials which are conveyed to the Template Server application running on IHS 735 via an appropriate communication protocol. The communication protocol could be HTTP or HTTPS or any number of internet protocols.

At block 904, template server reviews authentication credential, and if successful, execution continues to block 905.

At block 905, a virtual Well/Template selection page is created and conveyed via the communication protocol back to the client.

At block 906, the virtual Well/Template selection page is rendered to the local physical display.

At block 907, the user selects which template application to run. That information is then conveyed to Template Server 735 via the communication protocol.

At block 908, the Template Server invokes an instance of the selected template.

At block 909, the application retrieves data and builds the resulting display and returns that image to the client. This initiation of the execution may or may not be in response to receiving real time wellsite data updates. For example, the wellsite data may be stored for subsequent monitoring. In some embodiments, the processor may retrieve the wellsite monitoring application and initiate execution. The processor may retrieve the wellsite monitoring application from a local or remote machine-readable media. For example, the processor may retrieve the wellsite monitoring application from the non-volatile machine-readable memory. The monitoring application is designed, built and tested to run on the operating system of the application server. The hardware and operating system of the client machine does not have to support the monitoring application only the virtual terminal software, for example a web browser.

At block 910, the client renders the virtual display to the specific screen hardware to which it is attached. Execution continues to block 911.

At block 911, user input devices are sampled, the resulting values are then conveyed to the application via the communication protocol.

At block 912, the user inputs from the client are evaluated by the monitoring application and applied appropriately. These user inputs could include commands which are forwarded to the IHS at the well site being monitored, and in turn forwarded to either surface or downhole equipment.

At block 917, execution continues and the user input is evaluate to determine if it is a local application command or a command intended to be forwarded to the wellsite. If the command is a wellsite destined command it is forwarded to the IHS at the well site being monitored, via the Communication protocol 918. The Communication protocol would forward the command to IHS 735. IHS 735 would forward the command to IHS 734, which would in turn forwarded the command to the wellsite IHS 733 for and either surface or downhole equipment.

At block 914, execution continues and if the user selected something other than exit of the application, execution continues at block 909, and processes this loop continuously until the user selects exit. If the user selects exit, execution continues at block 916 and a message is conveyed back to the client. At block 913 the server evaluates if the user has selected exit. If no, execution continues to block 910 and continues in this loop until the user does select exit.

At block 916 the monitoring application terminates and an application termination message is sent via the communication protocol to the client. The client evaluates the termination message at block 913 and execution flow in the application returns to block 904 awaiting a login request.

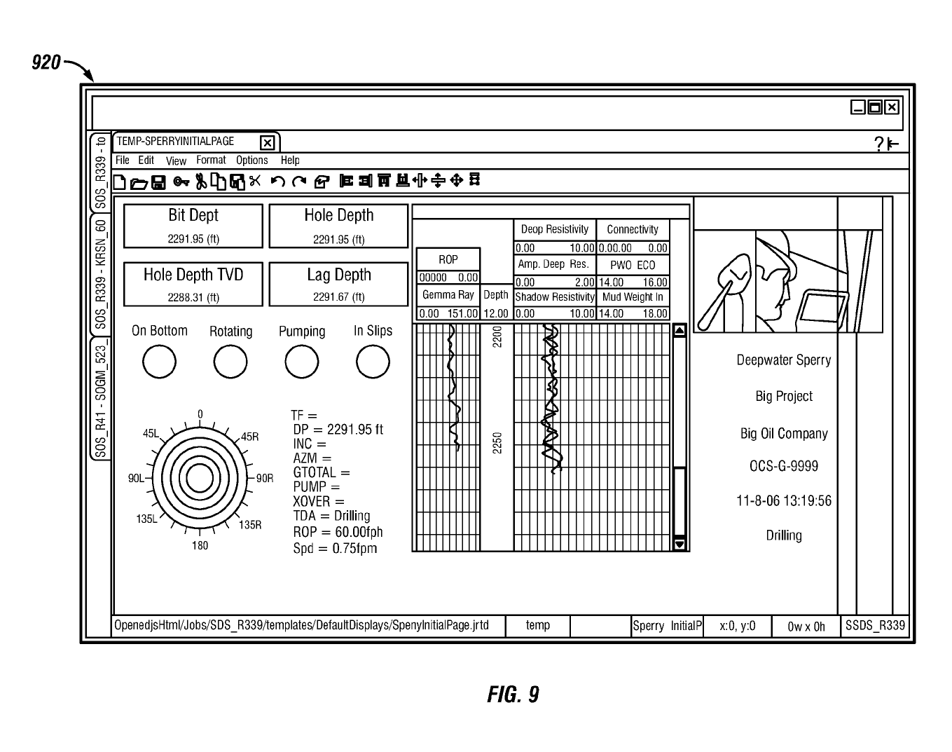

FIG. 9 shows an example of a graphical user interface (GUI) screenshot 920, also called a dashboard shot, of operational drilling and logging wellsite data displayed by the wellsite monitoring application 335. In one embodiment, mobile wellsite monitoring application 336 captures at least a portion of the data shown in screenshot 920, according to a predetermined template, as an image and transmits the image over network 102 via an RF link 108 to PMD 106. Various information may be shown in different predetermined selectable screenshots. In one embodiment, data from different wells may be selected by an expandable and contractible tree structure.

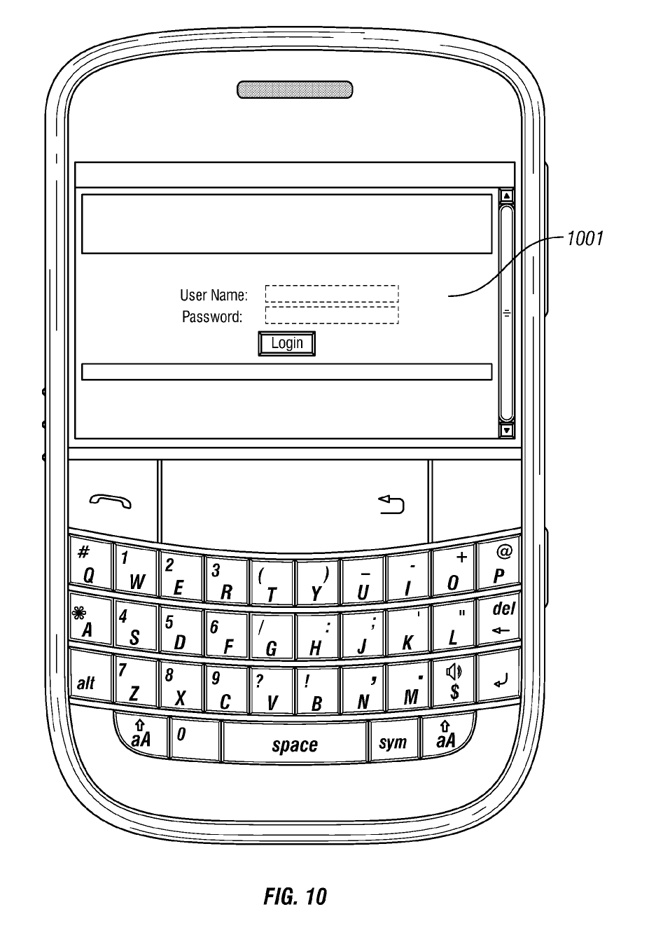

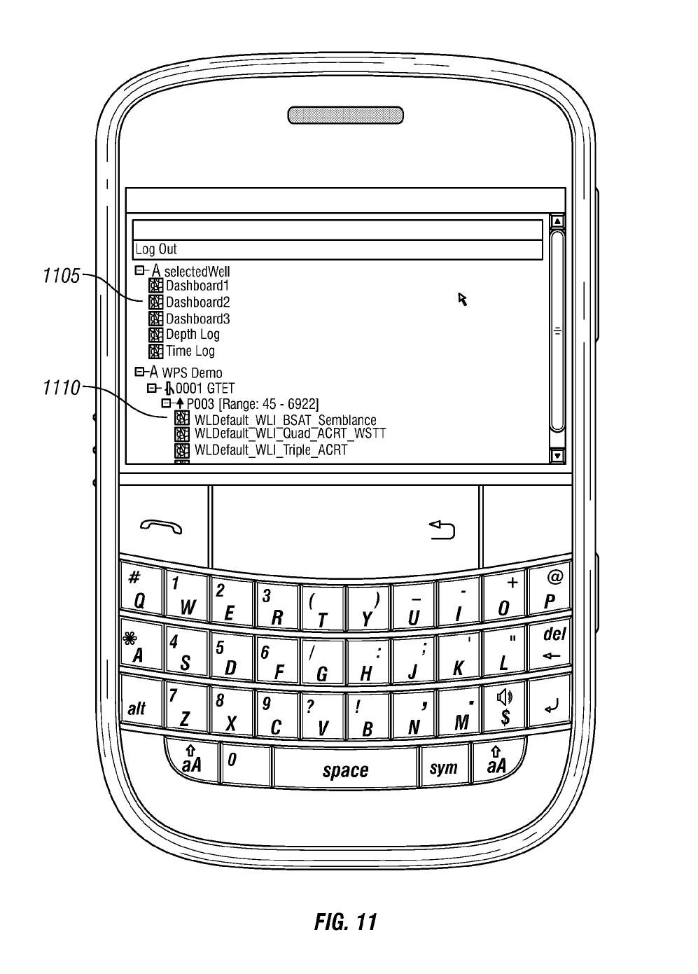

FIGS. 10-13 show different GUI screenshots for monitoring wellsite data on PMD 106. FIG. 10 illustrates an example GUI screenshot on PMD 106 for user login 1001, via cellular/WiFi communication, over network 102 to the mobile wellsite monitoring application 336, or to template server 735. FIG. 11 illustrates a GUI screenshot showing an expanded tree structure for an interactive selection of operational screenshot screens 1105 and well logging plots 1110. The expandable/contractible tree structure is enabled by the use of object oriented scripting language, for example Javascript.

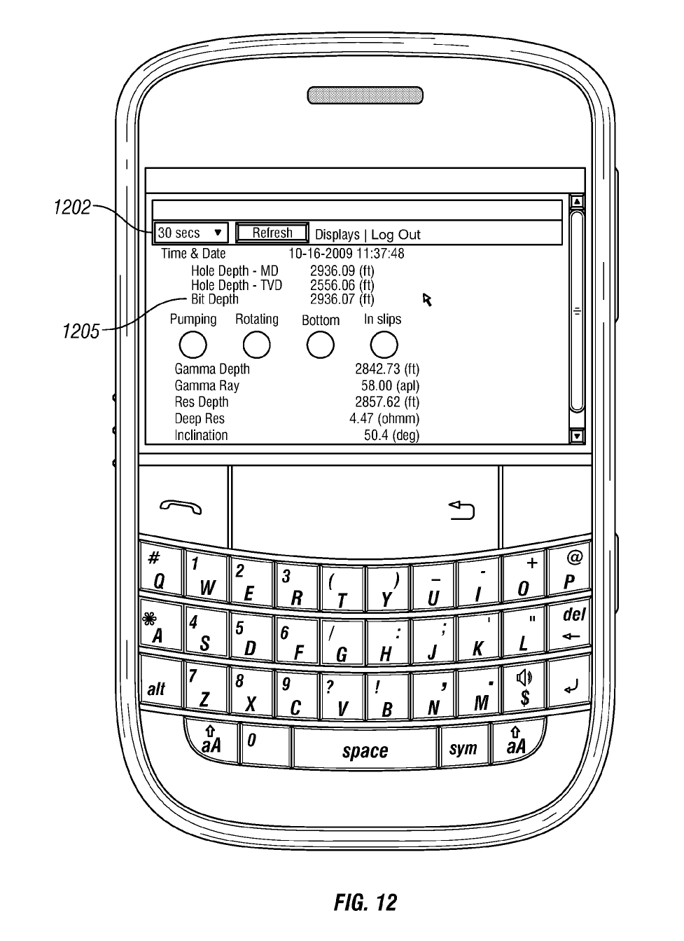

FIG. 12 illustrates a GUI screenshot of an operational dashboard with operating data 1205 and an interactive menu bar 1202. Interactive menu bar allows the user to select updates of the operational dashboard data using a manual refresh button or by selecting an automatic refresh at predetermined time intervals. An object oriented scripting language, for example Javascript, enables just the images on the display page to be updated and not the rest of the content of the page. It should be noted that, while shown in black and white in the attached figures, color features may be added to the screens to indicate out of range parameters.

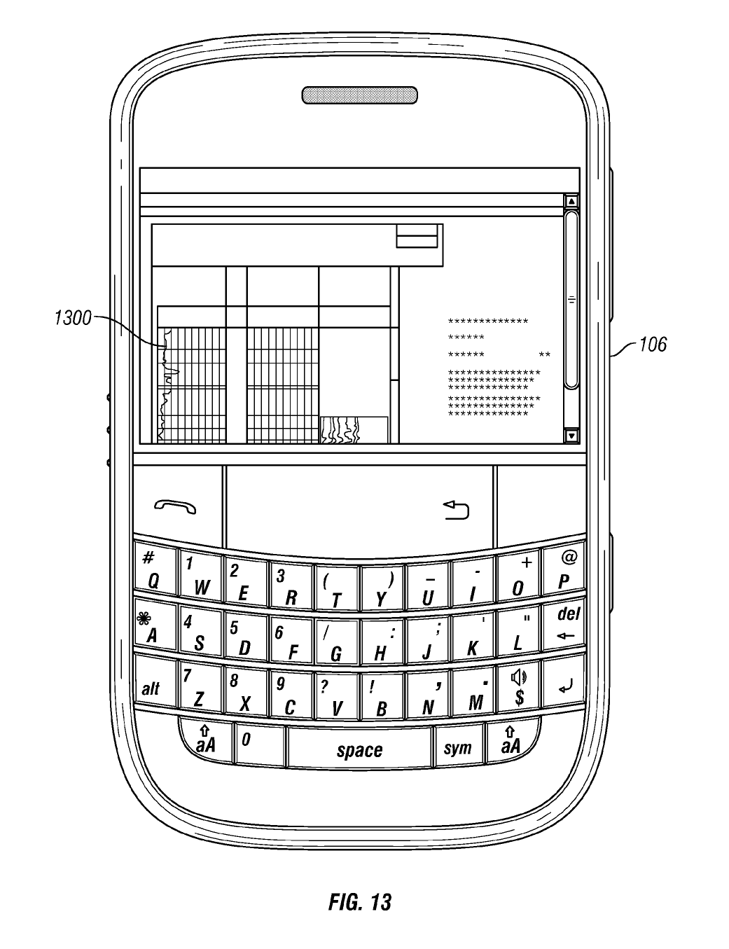

FIG. 13 illustrates a GUI screenshot of a well log 1300 displayed on PMD 106. While described above as simply reviewing wellsite data, PMD 106 may also be used to input changes to well site parameters. For example, changes in alarm ranges, directional targets, weight on bit, etc. may be dictated by remote evaluation of the data viewed on PMD 106.

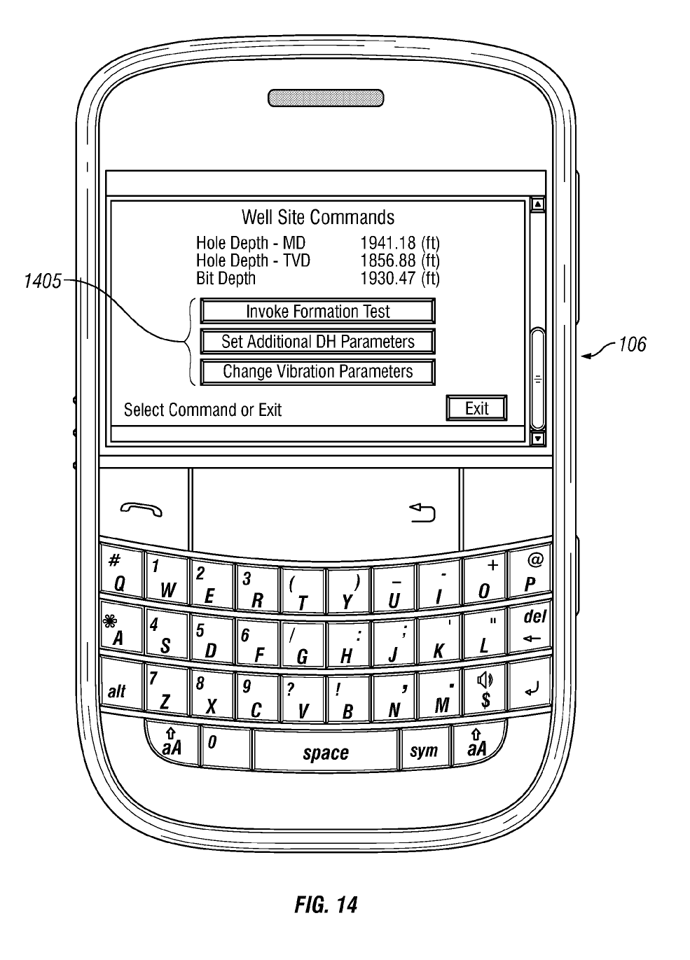

FIG. 14 illustrates a GUI screenshot of a command screen displayed on PMD 106. The commands displayed are examples of the commands discussed above and may be invoked and transmitted back to the wellsite via the network 102 for execution at the wellsite.

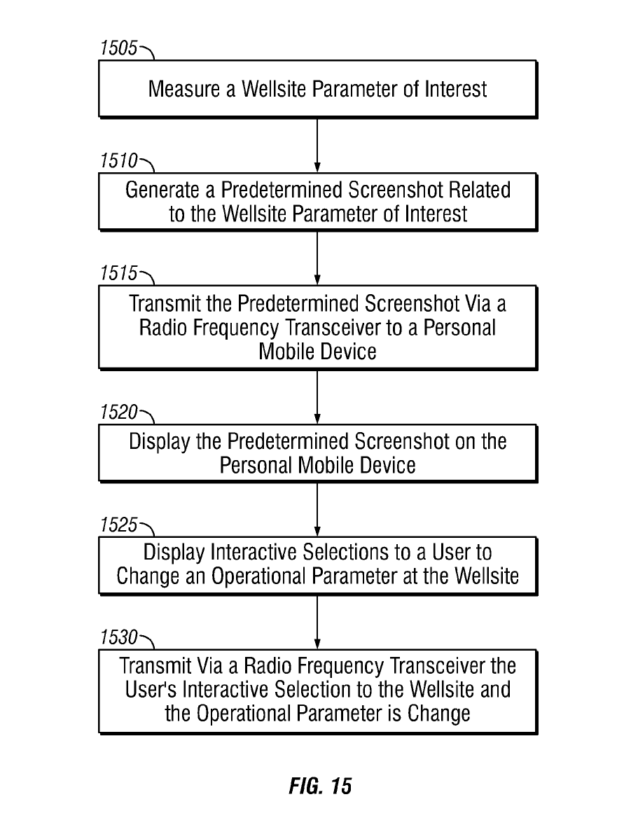

FIG. 15 shows one example of a flow chart for one embodiment of a method according to the present disclosure. In logic box 1505, a wellsite parameter of interest is measured. In logic box 1510, a predetermined screenshot related to the parameter of interest is generated. In logic box 1515, the predetermined screenshot is transmitted via a radio frequency transceiver to a personal mobile device. In logic box 1520, the predetermined screenshot is displayed on the personal mobile device. In logic box 1525, interactive selections are displayed on the personal mobile device to a user. In logic box 1530, the user's interactive selections are transmitted via a radio frequency transceiver to the wellsite and the operational parameter is changed.

The methods described above may also be embodied as a set of instructions on a computer readable medium comprising ROM, RAM, CD ROM, DVD, FLASH or any other computer readable medium, now known or unknown, that when executed causes a computer such as, for example, a processor in IHS 33, 533, 633, 733, 734, 735 to implement the methods of the present invention.

The discussion above has been primarily directed to the drilling and logging operation. One skilled in the art will appreciate that similar data review and control will also be advantageous to production systems, for example, as described in FIG. 6.

Numerous variations and modifications will become apparent to those skilled in the art. It is intended that the following claims be interpreted to embrace all such variations and modifications.

What is claimed is:

1. A system for remote monitoring of a wellsite operation comprising:
a sensor disposed at a wellsite to measure a parameter of interest;
an information handling system in data communication with the sensor, the information handling system acting according to programmed instructions to generate a predetermined screenshot related to the parameter of interest;
a radio frequency transceiver in data communication with the information handling system to transmit the predetermined screenshot; and
a personal mobile device comprising a radio frequency transceiver and a display wherein the personal mobile device receives and displays the transmitted predetermined screenshot on the display.

2. The system of claim 1 further comprising a wide area network coupling the information handling system to the radio frequency transceiver.

3. The system of claim 1 wherein the wellsite operation is chosen from the group consisting of: a drilling operation, a logging operation, a completion operation, and a production operation.

4. The system of claim 1 wherein the radio frequency transceiver comprises at least one of a cellular phone transceiver, a WiFi transceiver, and a satellite phone transceiver.

5. The system of claim 1 wherein the personal mobile device comprises at least one of a smartphone, a personal digital assistant, and a satellite phone.

6. The system of claim 1 wherein the personal mobile device has a display resolution of at least 160×160 pixels.

7. A method of remotely monitoring a wellsite operation comprising:
measuring a wellsite parameter of interest;
generating a predetermined screenshot related to the wellsite parameter of interest;
transmitting the predetermined screenshot via a radio frequency transceiver to a personal mobile device; and
displaying the predetermined screenshot on the personal mobile device.

8. The method of claim 7 further comprising authenticating the personal mobile device before transmitting the predetermined screenshot.

9. The method of claim 7 further comprising associating at least one predetermined screenshot with a user authentication.

10. The method of claim 9 further comprising displaying a selection tree on the personal mobile device for a user to interactively select from the at least one predetermined screenshot associated with the user authentication.

11. The method of claim 9 further comprising displaying interactive selections to allow a user to transmit a change in an operational parameter to the wellsite.

12. The method of claim 7 wherein the radio frequency transceiver comprises at least one of a cellular phone transceiver, a WiFi transceiver, and a satellite phone transceiver.

13. The method of claim 7 wherein the personal mobile device comprises at least one of a smartphone, a personal digital assistant, and a satellite phone.

14. The method of claim 7 wherein transmitting the predetermined screenshot via a radio frequency transceiver to a personal mobile device comprises transmitting the predetermined screenshot across a wide area network to the radio frequency transmitter.

15. A computer readable medium containing a set of instructions that when executed by an information handling system causes the information handling system to perform a method comprising:
receiving a measured wellsite parameter of interest;
generating a predetermined screenshot related to the measured wellsite parameter of interest;
authenticating a personal mobile device for access to the information handling system via a network connection;
transmitting the predetermined screenshot via the network connection to the personal mobile device.

16. The computer readable medium of claim 15 further comprising associating at least one predetermined screenshot with a user authentication.

17. The computer readable medium of claim 15 further comprising transmitting a selection tree to the personal mobile device for a user to interactively select from the at least one predetermined screenshot associated with the user authentication.

18. The computer readable medium of claim 17 further comprising transmitting an interactive selection to the personal mobile device to allow a user to transmit a change in an operational parameter to the wellsite.
